(19) United States
(12) Patent Application Publication
(10) Pub. No.: US 2024/0128451 A1
(43) Pub. Date: Apr. 18, 2024

(54) POSITIVE ELECTRODE FOR ALL-SOLID-STATE RECHARGEABLE BATTERY AND ALL-SOLID-STATE RECHARGEABLE BATTERY

(71) Applicant: SAMSUNG SDI CO., LTD., Yongin-si (KR)

(72) Inventors: Pilsang YUN, Yongin-si (KR); Do-Yu KIM, Yongin-si (KR); Hyunbeom KIM, Yongin-si (KR)

(21) Appl. No.: 18/378,746

(22) Filed: Oct. 11, 2023

(30) Foreign Application Priority Data
Oct. 14, 2022 (KR) 10-2022-0132691

(51) Int. Cl. H01M 4/58; H01M 4/525; H01M 10/0562

(52) U.S. Cl. CPC H01M 4/5825; H01M 4/525; H01M 10/0562; H01M 2004/028

(57) ABSTRACT

A positive electrode for an all-solid-state rechargeable battery, the positive electrode includes a current collector; and a positive electrode active material layer on the current collector, wherein the positive electrode active material layer includes a positive electrode active material and a solid electrolyte, the solid electrolyte includes sulfide solid electrolyte particles, and a lithium-metal-phosphate on a surface of the sulfide solid electrolyte particles, and in an X-ray diffraction analysis of the solid electrolyte, a full width at half maximum of a main peak is less than or equal to about 0.160.

### CROSS-REFERENCE TO RELATED APPLICATION

This application claims priority to and the benefit of Korean Patent Application No. 10-2022-0132691 filed in the Korean Intellectual Property Office on Oct. 14, 2022, the entire contents of which are incorporated herein by reference.

### BACKGROUND

### 1. Field

Embodiments relate to positive electrodes for all-solid-state rechargeable batteries and all-solid rechargeable batteries.

### 2. Description of the Related Art

Recently, as a risk of explosion of a battery using a liquid electrolyte has been reported, development of an all-solid-state battery has been actively conducted.

### SUMMARY

The embodiments may be realized by providing a positive electrode for an all-solid-state rechargeable battery, the positive electrode including a current collector; and a positive electrode active material layer on the current collector, wherein the positive electrode active material layer includes a positive electrode active material and a solid electrolyte, the solid electrolyte includes sulfide solid electrolyte particles, and a lithium-metal-phosphate on a surface of the sulfide solid electrolyte particles, and in an X-ray diffraction analysis of the solid electrolyte, a full width at half maximum of a main peak is less than or equal to about 0.160.

The metal may be Al, B, Ca, Ce, Cr, Fe, Mg, Mo, Nb, Si, Sn, Sr, Ta, V, W, or Zr.

The lithium-metal-phosphate may be included in the solid electrolyte in an amount of about 0.01 wt % to about 3 wt %, based on a total weight of the solid electrolyte.

The lithium-metal-phosphate may be included in the solid electrolyte in an amount of about 0.01 wt % to about 0.8 wt %, based on a total weight of the solid electrolyte.

The lithium-metal-phosphate may be amorphous.

The sulfide solid electrolyte particles may include an argyrodite-type sulfide.

An average particle diameter (D50) of the solid electrolyte may be about 0.1 μm to about 5.0 μm.

An average particle diameter (D50) of the sulfide solid electrolyte may be about 0.1 μm to about 2.0 μm.

A value of (D90-D10)/D50 in a particle size distribution for the solid electrolyte may be greater than about 1 and less than or equal to about 5.

The solid electrolyte may be included in the positive electrode active material layer in an amount of about 0.5 wt % to about 35 wt %, based on a total weight of the positive electrode active material layer.

The positive electrode active material may be in the form of particles, and the particles may not include a buffer layer.

The positive electrode active material may include a lithium cobalt oxide, lithium nickel oxide, a lithium nickel cobalt oxide, a lithium nickel cobalt aluminum oxide, a lithium nickel cobalt manganese oxide, a lithium nickel manganese oxide, a lithium manganese oxide, a lithium iron phosphate, or a combination thereof.

The positive electrode active material may include a lithium nickel oxide represented by Chemical Formula 1, a lithium cobalt oxide represented by Chemical Formula 2, a lithium iron phosphate compound represented by Chemical Formula 3, or a combination thereof,

Liₐ₁Niₓ₁M¹_{y1}M²_{1-x1-y1}O₂ [Chemical Formula 1]

in Chemical Formula 1, 0.9≤a1≤1.8, 0.3≤x1≤1, 0≤y1≤0.7, and M¹ and M² are each independently Al, B, Ba, Ca, Ce, Co, Cr, Cu, F, Fe, Mg, Mn, Mo, Nb, P, S, Si, Sr, Ti, V, W, or Zr,

Liₐ₂Coₓ₂M³₁₋ₓ₂O₂ [Chemical Formula 2]

in Chemical Formula 2, 0.9≤a2≤1.8, 0.6≤x2≤1, and M³ is Al, B, Ba, Ca, Ce, Cr, Cu, F, Fe, Mg, Mn, Mo, Nb, P, S, Si, Sr, Ti, V, W, or Zr, and

Liₐ₃Feₓ₃M⁴₍₁₋ₓ₃₎PO₄ [Chemical Formula 3]

in Chemical Formula 3, 0.9≤a3≤1.8, 0.6≤x3≤1, and M⁴ is Al, B, Ba, Ca, Ce, Co, Cr, Cu, F, Fe, Mg, Mn, Mo, Nb, P, S, Si, Sr, Ti, V, W, or Zr.

An average particle diameter (D50) of the positive electrode active material may be about 3 μm to about 25 μm.

The positive electrode active material layer may include about 50 wt % to about 99.5 wt % of the positive electrode active material, about 0.5 wt % to about 35 wt % of the solid electrolyte, about 0 wt % to about 10 wt % of a binder, and about 0 wt % to about 5 wt % of a conductive material, based on a total weight of the positive electrode active material layer.

The embodiments may be realized by providing an all-solid-state rechargeable battery including the positive electrode according to an embodiment; a negative electrode; and a solid electrolyte layer between the positive electrode and the negative electrode.

The negative electrode may include a current collector and a negative electrode active material layer or a negative electrode catalyst layer on the current collector.

The negative electrode may include a current collector, a negative electrode catalyst layer on the current collector, and a lithium metal layer formed during initial charging between the current collector and the negative electrode catalyst layer.

The solid electrolyte layer may include a solid electrolyte, and an average particle diameter (D50) of the solid electrolyte included in the positive electrode may be smaller than an average particle diameter (D50) of the solid electrolyte included in the solid electrolyte layer.

The average particle diameter (D50) of the solid electrolyte included in the positive electrode may be about 0.5 μm to about 2.0 μm, and the average particle diameter (D50) of the solid electrolyte included in the solid electrolyte layer may be about 2.1 μm to about 5.0 μm.

### BRIEF DESCRIPTION OF THE DRAWINGS

FIGS. 1 and 2 are schematic cross-sectional views of an all-solid rechargeable battery according to some example embodiments.

FIG. 3 shows a particle size distribution curves for the solid electrolytes prepared in Example 2 and Comparative Examples 1 to 3.

FIG. 4 is an X-ray diffraction analysis graph of the solid electrolytes and the coating agent (LZP) according to Examples 1 to 4 and Comparative Examples 1 and 2.

FIG. 5 is a graph showing full widths at half maximum (bar graph, left vertical axis) of the main peak and ion conductivity (dotted line graph, right vertical axis) in X-ray diffraction analyses of the solid electrolytes of Examples 1 to 4 and Comparative Examples 1 and 3.

FIG. 6 is a moisture stability evaluation graph for the solid electrolytes of Examples 2 and 3 and Comparative Example 3, the bar graphs corresponding to the left vertical axis shows ion conductivity before and after being left for 3 days, and the dotted line graph corresponding to the right vertical axis shows ion conductivity retention rate before and after being left for 3 days.

FIG. 7 is a graph showing cycle-life characteristics of all-solid-state rechargeable battery cells of Examples 1 to 3 and Comparative Examples 2 and 4.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that if/when a layer is referred to as being “between” two layers, it can be the only layer between the two layers, or one or more intervening layers may also be present. Like reference numerals refer to like elements throughout.

The terminology used herein is used to describe embodiments only, and is not intended to limit the embodiments. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

It will be understood that if an element such as a layer, film, region, or substrate is referred to as being “on” another element, it can be directly on the other element or intervening elements may also be present. In contrast, if/when an element is referred to as being “directly on” another element, there are no intervening elements present.

In addition, “layer” herein includes not only a shape formed on the whole surface if/when viewed from a plan view, but also a shape formed on a partial surface.

In addition, the average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of 50 volume % in a particle size distribution.

Herein, “or” is not to be construed as an exclusive meaning, e.g., “A or B” is construed to include A, B, A+B, and the like.

Positive Electrode for All-solid-state Rechargeable Battery

In some example embodiments, a positive electrode for an all-solid-state rechargeable battery may include a current collector and a positive electrode active material layer on the current collector. The positive electrode active material layer may include a positive electrode active material and a solid electrolyte. In an implementation, the solid electrolyte may include, e.g., sulfide solid electrolyte particles and lithium-metal-phosphate on the surface of the particles. In an X-ray diffraction analysis of the solid electrolyte, a full width at half maximum of a main peak may be less than or equal to about 0.160.

The positive electrode for an all-solid-state rechargeable battery may include a solid electrolyte having a uniform particle size distribution, high ion conductivity and high crystallinity, and excellent moisture stability, so that ion conductivity may be improved, thereby improving charging and discharging efficiency of the all-solid-state rechargeable battery. A carrier depletion layer may be controlled to help improve the capacity during the cycle-life. A reaction between the positive electrode active material and the solid electrolyte may be suppressed to help improve the capacity retention rate during the cycle-life. In the positive electrode according to the embodiment, it is possible to use the positive electrode active material without a buffer layer, e.g., the positive electrode active material of liquid electrolyte systems as it is. Even if such a positive electrode active material were to be used, capacity characteristics, charge and discharge efficiency, and cycle-life of the all-solid-state rechargeable battery characteristics may be improved.

Solid Electrolyte

The solid electrolyte may be one in which lithium-metal-phosphate is present in a film form or an island form on the surface of sulfide solid electrolyte particles. The solid electrolyte may include sulfide solid electrolyte particles and a coating layer on the surface of the particles, and the coating layer may include a lithium-metal-phosphate.

The solid electrolyte may have a form in which a lithium-metal-phosphate is coated on the surface of sulfide solid electrolyte particles, and crystallinity of the solid electrolyte may be sufficiently high to realize excellent ion conductivity and at the same time to have an appropriate particle size distribution without particle aggregation. As the crystallinity of the solid electrolyte increases or the size of the crystal increases, a full width at half maximum (FWHM) of a main peak may decrease in an X-ray diffraction analysis. The solid electrolyte according to some example embodiments may have a full width at half maximum of the main peak of less than or equal to about 0.160. Herein, the main peak refers to a peak having the highest diffraction intensity in X-ray diffraction analysis. The full width at half maximum of the main peak in the X-ray diffraction analysis of the solid electrolyte according to some example embodiments may be, e.g., less than or equal to about 0.159, or less than or equal to about 0.155. The ion conductivity may be improved as the full width at half maximum is reduced, e.g., as the crystallinity is increased. In an implementation, the crystal size may be increased, the grain boundary may be reduced, and the ion conductivity may be improved.

Sulfide solid electrolytes may have aggregated particles or may have a large particle size immediately after synthesis. They may be subjected to a process such as pulverization to adjust them to a particle size usable in a battery, the crystallinity may be lowered, and the ion conductivity may be lowered. In the solid electrolyte according to some example embodiments, by heating sulfide solid electrolyte particles in a specific temperature range while coating a lithium-metal-phosphate thereon, the crystallinity may be increased to adjust the full width at half maximum of the main peak to less than or equal to about 0.160. The particles may have an even particle size distribution without aggregation or growth, and the ion conductivity can be further improved.

Sulfide Solid Electrolyte Particles

The sulfide solid electrolyte particles may include, e.g., Li₂S—P₂S₅, Li₂S—P₂S₅—LiX (in which X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n is each an integer and Z is Ge, Zn or Ga), Li₂S—GeS₂, Li₂S—SiS₂—Li₃PO₄, Li₂S—SiS₂-LiₚMO_{q}(in which p and q each an integer and M is P, Si, Ge, B, Al, Ga, or In), or a combination thereof.

Such a sulfide solid electrolyte may be obtained by, e.g., mixing Li₂S and P₂S₅ in a molar ratio of about 50:50 to about 90:10 or about 50:50 to about 80:20 and optionally performing heat treatment. Within the above mixing ratio ranges, a sulfide solid electrolyte having excellent ion conductivity may be prepared. The ion conductivity may be further improved by adding, e.g., SiS₂, GeS₂, B₂S₃, or the like as other components thereto.

Mechanical milling or a solution method may be applied as a mixing method of sulfur-containing raw materials for preparing a sulfide solid electrolyte. The mechanical milling may include starting materials into particulates by putting the starting materials, ball mills, and the like in a reactor and vigorously stirring them. The solution method may include mixing the starting materials in a solvent to obtain a solid electrolyte as a precipitate. In addition, in the case of heat treatment after mixing, crystals of the solid electrolyte may be more robust and ion conductivity may be improved. In an implementation, the sulfide solid electrolyte may be prepared by mixing sulfur-containing raw materials and performing heat treatment two or more times. In this case, a sulfide solid electrolyte having high ion conductivity and robustness may be prepared.

The sulfide solid electrolyte particles according to some example embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ion conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

In an implementation, the sulfide solid electrolyte particles may include argyrodite-type sulfide. The argyrodite-type sulfide may be, e.g., represented by the chemical formula, LiₐM_{b}P_{c}S_{d}Aₑ (in which a, b, c, d, and e are each independently 0 or more and 12 or less, M is Ge, Sn, Si, or a combination thereof, and A is F, Cl, Br, or I). In an implementation, it may be represented by the chemical formula of Li₇₋ₓPS₆₋ₓAₓ (in which x is 0.2 or more and 1.8 or less, and A is F, Cl, Br, or I). In an implementation, the argyrodite-type sulfide may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide solid electrolyte particles including such argyrodite-type sulfide may have high ion conductivity, e.g., close to the range of about 10⁻⁴ to about 10⁻² S/cm, which is the ion conductivity of liquid electrolytes at ambient temperature, and may form an intimate bond between the positive electrode active material and the solid electrolyte without causing a decrease in ion conductivity, and also an intimate interface between the electrode layer and the solid electrolyte layer. An all-solid-state battery including the same may have improved battery performance such as rate capability, coulombic efficiency, and cycle-life characteristics.

The argyrodite-type sulfide solid electrolyte may be prepared, e.g., by mixing lithium sulfide and phosphorus sulfide, and optionally lithium halide. Heat treatment may be performed after mixing. The heat treatment may include, e.g., two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D50) of the sulfide solid electrolyte particles according to some example embodiments may be less than or equal to about 5.0 μm, e.g., about 0.1 μm to about 5.0 μm, about 0.1 μm to about 4.0 μm, about 0.1 μm to about 3.0 m, about 0.5 μm to about 2.0 μm, or about 0.1 μm to about 1.5 μm. The sulfide solid electrolyte particles having this particle size range may effectively penetrate between positive electrode active materials, and may have excellent contact with the positive electrode active material and connectivity between solid electrolyte particles. The average particle diameter of the sulfide solid electrolyte particles may be measured using a microscope image, e.g., a particle size distribution may be obtained by measuring the size of about 20 particles in a scanning electron microscope image, and D50 may be calculated therefrom.

Lithium-Metal-Phosphate

The lithium-metal-phosphate is a phosphate including lithium and a metal other than lithium. Herein, the metal includes general metals, transition metals, and semi-metals. In the lithium-metal-phosphate, the metal may include, e.g., Al, B, Ca, Ce, Cr, Fe, Mg, Mo, Nb, Si, Sn, Sr, Ta, V, W, or Zr.

The lithium-metal-phosphate may be amorphous. In an implementation, amorphous lithium-metal-phosphate may be coated on the sulfide solid electrolyte particles, and the prepared solid electrolyte may realize higher ion conductivity and interfacial resistance with other solid particles such as a positive electrode active material in a battery, may prevent aggregation of solid electrolyte particles, may improve ion conductivity, and may improve capacity characteristics, cycle-life characteristics, and the like.

In the solid electrolyte according to some example embodiments, the lithium-metal-phosphate may be included in an amount of about 0.01 wt % to about 3 wt %, e.g., about 0.01 wt % to about 2 wt %, about 0.01 wt % to about 1 wt %, about 0.01 wt % to about 0.8 wt %, or about 0.1 wt % to about 1.0 wt %, based on a total weight of the solid electrolyte. Maintaining the content of lithium-metal-phosphate is as described above may help ensure that the solid electrolyte exhibits an appropriate particle size distribution without particle aggregation while realizing high ion conductivity. In an implementation, the content of lithium-metal-phosphate may be, e.g., 0.01 wt % to 0.8 wt %, based on a total weight of the solid electrolyte, and the surface of the sulfide solid electrolyte particles may be evenly coated with lithium-metal-phosphate. Accordingly, the ion conductivity and moisture stability of the solid electrolyte may be further improved, and the efficiency and cycle-life characteristics of the battery may be further improved.

An average particle diameter (D50) of the solid electrolyte may be about 0.1 μm to about 5.0 μm, e.g., about 0.1 μm to about 4.0 μm, about 0.1 μm to about 3.0 μm, about 0.5 μm to about 2.0 μm, or about 0.1 μm to about 1.5 μm. Such a solid electrolyte may help effectively penetrate between positive electrode active materials, and may have excellent contact with the positive electrode active material and connectivity between solid electrolyte particles. The average particle diameter of the solid electrolyte may be measured using a microscope image, e.g., a particle size distribution may be obtained by measuring the size of about 20 particles in a scanning electron microscope image, and D50 may be calculated therefrom.

The solid electrolyte according to some example embodiments may be characterized by having a uniform particle size distribution without particle aggregation. In an implementation, a value of (D90-D10)/D50 in the particle size distribution for the solid electrolyte may be greater than about 1 and less than or equal to about 5, e.g., about 1.1 to about 4.0, about 1.1 to about 3.0, or about 1.1 to about 2.0. The (D90-D10)/D50 value may indicate a degree of broadness of the peak in the particle size distribution graph for the solid electrolyte, e.g., the horizontal axis represents the particle size (m) and the vertical axis represents the cumulative volume % of the particles. The smaller the corresponding number, the narrower the peak width of the graph, which may be interpreted as having a uniform particle size. Herein, D10 means a diameter of particles whose cumulative volume is 10 volume % in the particle size distribution, D50 means a diameter of particles whose cumulative volume is 50 volume % in the particle size distribution, and D90 means a diameter of particles whose cumulative volume is 90 volume % in the particle size distribution.

The D10 of the solid electrolyte may be, e.g., about 0.05 μm to about 0.7 μm, about 0.05 μm to about 0.6 μm, about 0.1 μm to about 0.5 μm, or about 0.2 μm to about 0.4 μm. In an implementation, the D90 of the solid electrolyte may be, e.g., about 0.9 m to about 5.0 μm, about 1.0 μm to about 4.0 μm, about 1.0 μm to about 3.0 μm, or about 1.2 μm to about 2.0 μm. Maintaining the particle size distribution of the solid electrolyte as described above may help ensure that battery performance may be improved by realizing high energy density while implementing excellent ion conductivity.

The solid electrolyte may have an ion conductivity of greater than or equal to about 2.9 mS/cm at 25° C., e.g., about 2.9 mS/cm to about 5.0 mS/cm, about 3.0 mS/cm to about 4.5 mS/cm, or about 3.0 mS/cm to about 4.0 mS. The ion conductivity may be measured through electrochemical impedance spectroscopy (EIS).

A solid electrolyte according to some example embodiments may be prepared by mixing sulfide solid electrolyte particles and a lithium-metal-phosphate and performing heat treatment at about 250° C. to about 350° C.

A solid electrolyte may have an appropriate particle size distribution to exhibit excellent ion conduction performance in a battery and implement high energy density, and implement excellent particle fluidity, e.g., a high-density electrode plate and electrolyte film. At the same time, the solid electrolyte may be able to exhibit improved ion conductivity by maintaining high crystallinity. A sulfide solid electrolyte may be a material capable of realizing high ion conductivity among various solid electrolytes. Immediately after synthesis at a high temperature, the particles may be severely aggregated or have a large particle size, and it may be necessary to pulverize them. The ion conductivity may decrease due to the pulverizing operation, and when heat treatment is performed to increase the ion conductivity, the particles could re-aggregate and grow. In an implementation, the heat treatment may be performed in a temperature range of about 250° C. to about 350° C. while coating lithium-metal-phosphate on the pulverized sulfide solid electrolyte particles, the crystallinity of the solid electrolyte may be increased, the ion conductivity may be improved, and at the same time, particle aggregation and growth may be suppressed to provide a solid electrolyte having an appropriate particle size distribution.

Maintaining the temperature of the heat treatment at about 250° C. or greater may help ensure that crystallinity is sufficiently increased, and high ion conductivity is realized. Maintaining the temperature of the heat treatment at about 350° C. or less may help ensure that aggregation and growth of particles does not occur, so that an appropriate particle size distribution may be obtained, and thus crystallinity may not be lowered. The higher the heat treatment at a higher temperature, the more coating agents may be required, which could cause deterioration of the ion conductivity.

The heat treatment may be performed under a nitrogen atmosphere or an inert gas atmosphere, e.g., He, Ar, or the like. In an implementation, the heat treatment may be performed for about 0.5 to about 10 hours, e.g., for about 1 to about 8 hours. In the case of heat treatment under these conditions, the prepared solid electrolyte may realize an appropriate particle size distribution while exhibiting excellent ion conductivity.

The lithium-metal-phosphate mixed in the method for preparing a solid electrolyte may be in the form of particles, and its average particle diameter (D50) may be, e.g., about 0.01 μm to about 1.0 μm, about 0.01 μm to about 0.9 μm, about 0.01 μm to about 0.8 μm, or about 0.01 μm and about 0.5 μm. The average particle diameter of the lithium-metal-phosphate may be smaller than that of the sulfide solid electrolyte particles. Maintaining the particle size of the lithium-metal-phosphate within the above ranges may help ensure that it can be evenly coated on the surface of the sulfide solid electrolyte particles, may help sufficiently increase ion conductivity of the solid electrolyte, and may help improve moisture stability.

A method for preparing a solid electrolyte may include, e.g., mixing sulfur-containing raw materials, performing heat treatment to synthesize a sulfide solid electrolyte, pulverizing the synthesized sulfide solid electrolyte, and mixing the pulverized sulfide solid electrolyte particles and lithium-metal-phosphate, and performing heat treatment at about 250° C. to about 350° C. to obtain a solid electrolyte in which lithium-metal-phosphate is coated on the surface of the sulfide solid electrolyte particles.

In an implementation, the mixing of the sulfide solid electrolyte particles and lithium-metal-phosphate and performing heat treatment may be referred to as a type of dry coating method. Unlike oxide inorganic solid electrolytes or positive electrode active materials, sulfide solid electrolytes may have characteristics in that wet coating may be difficult and vulnerable to high-temperature heat treatment, and thus the sulfide solid electrolytes may need to address or account for difficult coating conditions. In addition, wet coating methods may use organic solvents or alkoxide raw materials, and accordingly, carbon components may remain locally after coating, which may adversely affect conductivity and the like. The method of preparing a solid electrolyte may have different conditions from coating other types of solid electrolyte particles, and is also distinguished from general wet coating.

A content of the solid electrolyte may be about 0.5 wt % to about 35 wt %, e.g., about 1 wt % to about 35 wt %, about 5 wt % to about 30 wt %, about 8 wt % to about 25 wt %, or about 10 wt % to about 20 wt %, based on a total weight of the positive electrode active material layer.

Positive Electrode Active Material

The positive electrode active material may be an active material suitable for all-solid-state rechargeable battery. In an implementation, the positive electrode active material may be a compound being capable of intercalating and deintercalating lithium, and may include a compound represented by one of the following chemical formulae.

LiₐA_{1-b}X_{b}D′₂(0.90≤a≤1.8, 0≤b≤0.5);

LiₐA_{1-b}X_{b}O_{2-c}D′_{c}(0.90≤a≤1.8, 0≤b≤0.5, 0≤c≤0.05);

LiₐE_{1-b}X_{b}O_{2-c}D′_{c}(0.90≤a≤1.8, 0≤b≤0.5, 0≤c≤0.05);

LiₐE_{2-b}X_{b}O_{4-c}D′_{c}(0.90≤a≤1.8, 0≤b≤0.5, 0≤c≤0.05);

LiₐNi_{1-b-c}Co_{b}X_{c}D′_{α}(0.90≤a≤1.8, 0≤b≤0.5, 0≤c≤0.5, 0<α≤2);

LiₐNi_{1-b-c}CO_{b}X_{c}O_{2-α}T_{α}(0.90≤a≤1.8, 0≤b≤0.5, 0≤c≤0.05, 0<α≤2);

LiₐNi_{1-b-c}CO_{b}X_{c}O_{2-α}T₂(0.90≤a≤1.8, 0≤b≤0.5, 0≤c≤0.05, 0<α≤2);

LiₐNi_{1-b-c}Mn_{b}X_{c}D′_{α}(0.90≤a≤1.8, 0≤b≤0.5, 0≤c≤0.05, 0<α≤2);

LiₐNi_{1-b-c}Mn_{b}X_{c}O_{2-α}T_{α}(0.90≤a≤1.8, 0≤b≤0.5, 0≤c≤0.05, 0<α≤2);

LiₐNi_{1-b-c}Mn_{b}X_{c}O_{2-α}T₂(0.90≤a≤1.8, 0≤b≤0.5, 0≤c≤0.05, 0<α≤2);

LiₐNi_{b}E_{c}G_{d}O₂(0.90≤a≤1.8, 0≤b≤0.9, 0≤c≤0.5, 0.001≤d≤0.1);

LiₐNi_{b}Co_{c}Mn_{d}GₑO₂(0.90≤a≤1.8, 0≤b≤0.9, 0≤c≤0.5, 0≤d≤0.5, 0.001≤e≤

0.1);

LiₐNiG_{b}O₂(0.90≤a≤1.8, 0.001≤b≤0.1);

LiₐCoG_{b}O₂(0.90≤a≤1.8, 0.001≤b≤0.1);

LiₐMn_{1-b}G_{b}O₂(0.90≤a≤1.8, 0.001≤b≤0.1);

LiaMn₂GbO₄(0.90≤a≤1.8, 0.001≤b≤0.1);

LiₐMn_{1-g}G_{g}PO₄(0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2);

LiₐFePO₄(0.90≤a≤1.8).

In the chemical formulae, A may be, e.g., Ni, Co, Mn, or a combination thereof; X may be, e.g., Al, Ni, Co, Mn, Cr, Fe, Mg, Sr, V, rare earth elements, or a combination thereof, D′ may be, e.g., O, F, S, P, or a combination thereof, E may be, e.g., Co, Mn, or a combination thereof, T may be, e.g., F, S, P, or a combination thereof, G may be, e.g., Al, Cr, Mn, Fe, Mg, La, Ce, Sr, V, or a combination thereof, Q may be, e.g., Ti, Mo, Mn, or a combination thereof, Z may be, e.g., Cr, V, Fe, Sc, Y, or a combination thereof, and J may be, e.g., V, Cr, Mn, Co, Ni, Cu, or a combination thereof.

The positive electrode active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include a lithium nickel oxide represented by Chemical Formula 1, a lithium cobalt oxide represented by Chemical Formula 2, a lithium iron phosphate compound represented by Chemical Formula 3, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may each independently be, e.g., Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In Chemical Formula 2, 0.9≤a2≤1.8, 0.6≤x2≤1, and M³ may be, e.g., Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₍₁₋ₓ₃₎PO₄ [Chemical Formula 3]

In Chemical Formula 3, 0.9≤a3≤1.8, 0.6≤x3≤1, and M⁴ may be, e.g., Al, B, Ba, Ca, Ce, Co, Cr, Cu, F, Fe, Mg, Mn, Mo, Nb, P, S, Si, Sr, Ti, V, W, or Zr.

An average particle diameter (D50) of the positive electrode active material may be about 1 μm to about 25 μm, e.g., about 3 μm to about 25 μm, about 1 μm to about 20 m, about 1 μm to about 18 μm, about 3 μm to about 15 μm, or about 5 μm to about 15 μm. In an implementation, the positive electrode active material may include small particles having an average particle diameter (D50) of about 1 μm to about 9 μm and large particles having an average particle diameter (D50) of about 10 μm to about 20 μm. In an implementation, a mixing ratio of the small particles and the large particles may be in a weight ratio of about 10:90 to about 40:60. A positive electrode active material having such particle size ranges may be harmoniously mixed with other components in a positive electrode active material layer and may realize high capacity and high energy density.

The positive electrode active material may be in the form of secondary particles formed by aggregating a plurality of primary particles, or may be in the form of single particles. In an implementation, the positive electrode active material may have a spherical or near-spherical shape, or may have a polyhedral or amorphous shape.

Binder

In an implementation, the positive electrode active material layer may optionally further include a binder. The binder may facilitate attachment of the positive electrode active material particles and the solid electrolyte particles to each other, and also to facilitate attachment of the particles to the current collector. In an implementation, the binder may include, e.g., polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

In an implementation, the binder may be included in an amount of 0 wt % to about 10 wt %, about 0.1 wt % to about 10 wt %, or about 0.5 wt % to about 5 wt %, based on a total weight of each component of the positive electrode for an all-solid-state battery or a total weight of the positive electrode active material layer. Within the above content ranges, the binder may help sufficiently exhibit adhesive ability without deteriorating battery performance.

Conductive Material

In an implementation, the positive electrode active material layer may optionally further include a conductive material. The conductive material may impart conductivity to the electrode, and may include, e.g., a carbon material such as natural graphite, artificial graphite, carbon black, acetylene black, ketjen black, a carbon fiber, a carbon nanotube, or the like; a metal material including copper, nickel, aluminum, silver, or the like and in the form of a metal powder or a metal fiber; a conductive polymer such as a polyphenylene derivative; or a combination thereof.

In an implementation, the conductive material may be included in an amount of 0 wt % to about 5 wt %, about 0.1 wt % to about 5 wt %, or about 0.5 wt % to about 3 wt %, based on a total weight of each component of the positive electrode for an all-solid-state battery or a total weight of the positive electrode active material layer. In the above content ranges, the conductive material may help improve electrical conductivity without degrading battery performance.

In an implementation, the positive electrode active material layer may include about 50 wt % to about 99.5 wt % of the positive electrode active material, about 0.5 wt % to about 35 wt % of a solid electrolyte, about 0 wt % to about 10 wt % of a binder, and about 0 wt % to about 5 wt % of a conductive material.

In an implementation, the positive electrode active material layer may include about 50 wt % to about 99.3 wt % of a positive electrode active material, about 0.5 wt % to about 35 wt % of a solid electrolyte, 0.1 wt % to 10 wt % of a binder, and 0.1 wt % to 5 wt % of a conductive material.

In an implementation, the positive electrode active material layer may further include an oxide inorganic solid electrolyte in addition to the above-described solid electrolyte. The oxide inorganic solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (M═Te, Nb, or Zr; x is an integer of 1 to 10), or a combination thereof.

All-Solid-State Rechargeable Battery

In an implementation, an all-solid-state rechargeable battery may include the aforementioned positive electrode and negative electrode, and a solid electrolyte layer between the positive electrode and the negative electrode. The all-solid-state rechargeable battery may also be referred to as an all-solid-state battery or an all-solid-state rechargeable lithium battery.

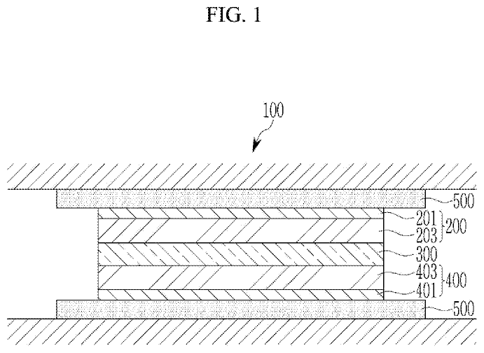

FIG. 1 is a cross-sectional view schematically illustrating an all-solid-state battery according to some example embodiments. Referring to FIG. 1, the all-solid-state battery 100 may have a structure that an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 are stacked, is inserted into a case such as a pouch and the like. The all-solid-state battery 100 may further include at least one elastic layer 500 on the outside of at least either one of the positive electrode 200 and the negative electrode 400. In an implementation, as illustrated in FIG. 1, one electrode assembly may include the negative electrode 400, the solid electrolyte layer 300, and the positive electrode 200, or two or more electrode assemblies may be stacked to manufacture an all-solid-state battery.

Negative Electrode

The negative electrode for an all-solid-state battery may include, e.g., a current collector and a negative electrode active material layer on the current collector. The negative electrode active material layer may include a negative electrode active material, and may further include a binder, a conductive material, or a solid electrolyte.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include, e.g., crystalline carbon, amorphous carbon, or a combination thereof, as a carbon negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, or the like.

The lithium metal alloy may include an alloy of lithium and another metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ(0<x<2), a Si-Q alloy (in which Q is an alkali metal, an alkaline-earth metal, a Group 13 element, a Group 14 element, a Group 15 element, a Group 16 element, a transition metal, a rare earth element, and a combination thereof, and not Si) and the Sn negative electrode active material may include Sn, SnO₂, a Sn—R alloy (in which R is an alkali metal, an alkaline-earth metal, a Group 13 element, a Group 14 element, a Group 15 element, a Group 16 element, a transition metal, a rare earth element, and a combination thereof, and not Sn). At least one of these materials may be mixed with SiO₂. The elements Q and R may be, e.g., Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer on the surface of the core. The crystalline carbon may be artificial graphite, natural graphite, or a combination thereof. The amorphous carbon precursor may be a coal pitch, mesophase pitch, petroleum pitch, coal oil, petroleum heavy oil, or a polymer resin such as a phenol resin, a furan resin, or a polyimide resin. In an implementation, the content of silicon may be about 10 wt % to about 50 wt %, based on the total weight of the silicon-carbon composite. In an implementation, the content of the crystalline carbon may be about 10 wt % to about 70 wt %, based on the total weight of the silicon-carbon composite, and the content of the amorphous carbon may be about 20 wt % to about 40 wt %, based on the total weight of the silicon-carbon composite. In an implementation, a thickness of the amorphous carbon coating layer may be about 5 nm to about 100 nm.

The average particle diameter (D50) of the silicon particles may be about 10 nm to about 20 μm, e.g., about 10 nm to about 500 nm. The silicon particles may be present in an oxidized form, and an atomic content ratio of Si:O in the silicon particle indicating a degree of oxidation may be about 99:1 to about 33:67. The silicon particles may be SiOₓ particles, and a range of x in SiOₓ may be greater than about 0 and less than about 2. The average particle diameter (D50) may be measured by a microscope image or a particle size analyzer, and may mean a diameter (D50) of particles having a cumulative volume of 50 volume % in a particle size distribution.

The Si negative electrode active material or Sn negative electrode active material may be mixed with the carbon negative electrode active material. A mixing ratio of the Si negative electrode active material or Sn negative electrode active material with the carbon negative electrode active material may be a weight ratio of about 1:99 to about 90:10.

In the negative electrode active material layer, the negative electrode active material may be included in an amount of about 95 wt % to about 99 wt %, based on the total weight of the negative electrode active material layer.

In an implementation, the negative electrode active material layer may further include, e.g., a binder, and may optionally further include a conductive material. The content of the binder in the negative electrode active material layer may be about 1 wt % to about 5 wt %, based on the total weight of the negative electrode active material layer. In an implementation, the conductive material may be further included, and the negative electrode active material layer may include about 90 wt % to about 98 wt % of the negative electrode active material, about 1 wt % to about 5 wt % of the binder, and about 1 wt % to about 5 wt % of the conductive material.

The binder may facilitate adhering of the negative electrode active material particles to each other and also adhering the negative electrode active material to the current collector. The binder may be a water-insoluble binder, a water-soluble binder, or a combination thereof.

The water-insoluble binder may include, e.g., polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include, e.g., a rubber binder or a polymer resin binder. The rubber binder may include, e.g., a styrene-butadiene rubber, an acrylated styrene-butadiene rubber, an acrylonitrile-butadiene rubber, an acrylic rubber, a butyl rubber, a fluororubber, or a combination thereof. The polymer resin binder may include, e.g., polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

In an implementation, a water-soluble binder may be used as the negative electrode binder, a thickener capable of imparting viscosity may be used together therewith, and the thickener may include, e.g., a cellulose compound. The cellulose compound may include carboxymethyl cellulose, hydroxypropylmethyl cellulose, methyl cellulose, an alkali metal salt thereof, or a combination thereof. The alkali metal may be Na, K, or Li. The amount of the thickener used may be about 0.1 parts by weight to about 3 parts by weight, based on 100 parts by weight of the negative electrode active material.

The conductive material may impart conductivity to the electrode, and may include, e.g., a carbon material such as natural graphite, artificial graphite, carbon black, acetylene black, ketjen black, a carbon fiber, carbon nanotube, or the like; a metal material of a metal powder or a metal fiber including copper, nickel, aluminum silver, or the like; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

In an implementation, the negative electrode for the all-solid-state battery may be a precipitation-type negative electrode. The precipitation-type negative electrode may be a negative electrode that has no negative electrode active material during the assembly of a battery but in which a lithium metal or the like are precipitated during the charge of the battery and serve as a negative electrode active material.

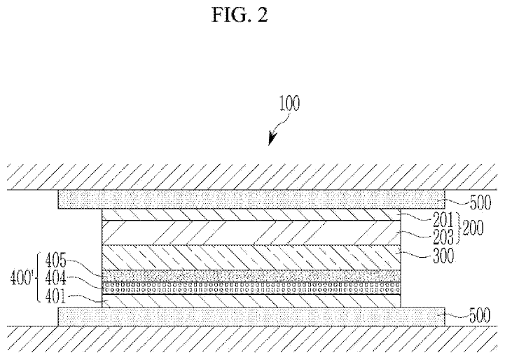

FIG. 2 is a schematic cross-sectional view of an all-solid-state battery including a precipitation-type negative electrode. Referring to FIG. 2, the precipitation-type negative electrode 400′ may include the current collector 401 and a negative electrode catalyst layer 405 on the current collector. The all-solid-state battery having this precipitation-type negative electrode 400′ may be initially charged in absence of a negative electrode active material, and a lithium metal with high density or the like may be precipitated between the current collector 401 and the negative electrode catalyst layer 405 during the charge and form a lithium metal layer 404, which may work as a negative electrode active material. Accordingly, the precipitation-type negative electrode 400′, in the all-solid-state battery which is charged more than once, may include the current collector 401, the lithium metal layer 404 on the current collector, and the negative electrode catalyst layer 405 on the metal layer 404. The lithium metal layer 404 may be a layer of the lithium metal or the like precipitated during the charge of the battery and may be called to be a metal layer, a negative electrode active material layer, or the like.

The negative electrode catalyst layer 405 may include a metal, a carbon material, or a combination thereof which plays a role of a catalyst.

The metal may include, e.g., gold, platinum, palladium, silicon, silver, aluminum, bismuth, tin, zinc, or a combination thereof, and may be composed of one selected therefrom or an alloy of more than one. In an implementation, the metal may be present in particle form, and an average particle diameter (D50) thereof may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

In an implementation, the negative electrode catalyst layer 405 may include the metal and the carbon material, and the metal and the carbon material may be, e.g., mixed in a weight ratio of about 1:10 to about 2:1. In an implementation, the precipitation of the lithium metal may be effectively promoted and improve characteristics of the all-solid-state battery. The negative electrode catalyst layer 405 may include, e.g., a carbon material on which a catalyst metal is supported or a mixture of metal particles and carbon material particles.

The negative electrode catalyst layer 405 may include, e.g., the metal and amorphous carbon, and in this case, the deposition of lithium metal may be effectively promoted.

The negative electrode catalyst layer 405 may further include a binder, and the binder may be a conductive binder. In an implementation, the negative electrode catalyst layer 405 may further include other additives, e.g., a filler, a dispersant, or an ion conducting agent.

The negative electrode catalyst layer 405 may have a thickness of, e.g., about 100 nm to about 20 μm, about 500 nm to about 10 μm, or about 1 μm to about 5 μm.

The precipitation-type negative electrode 400′ may further include a thin film, e.g., on the surface of the current collector, e.g., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and much improve characteristics of the all-solid-state battery. The thin film may be formed, e.g., using a vacuum deposition method, a sputtering method, a plating method, or the like. The thin film may have, e.g., a thickness of about 1 nm to about 500 nm.

Solid Electrolyte Layer

The solid electrolyte layer 300 may include a sulfide solid electrolyte or an oxide solid electrolyte. Details of the sulfide solid electrolyte and the oxide solid electrolyte may be as described above.

In an implementation, the solid electrolyte included in the positive electrode 200 and the solid electrolyte included in the solid electrolyte layer 300 may include the same compound or different compounds. In an implementation, both the positive electrode 200 and the solid electrolyte layer 300 may include an argyrodite-type sulfide solid electrolyte, and overall performance of the all-solid-state rechargeable battery may be improved. In an implementation, both the positive electrode 200 and the solid electrolyte layer 300 may include the aforementioned coated solid electrolyte, and the all-solid-state rechargeable battery may implement excellent initial efficiency and cycle-life characteristics while implementing high capacity and high energy density.

In an implementation, the average particle diameter (D50) of the solid electrolyte included in the positive electrode 200 may be smaller than the average particle diameter (D50) of the solid electrolyte included in the solid electrolyte layer 300. In this case, overall performance may be improved by increasing the mobility of lithium ions while maximizing the energy density of the all-solid-state battery. In an implementation, the average particle diameter (D50) of the solid electrolyte included in the positive electrode 200 may be about 0.1 μm to about 1.0 μm, or about 0.1 μm to about 0.8 μm, and the average particle diameter (D50) of the solid electrolyte included in the solid electrolyte layer 300 may be about 1.5 μm to about 5.0 μm, or about 2.0 μm to about 4.0 μm, or about 2.5 μm to about 3.5 μm. Within the particle size ranges described above, the energy density of the all-solid-state rechargeable battery may be maximized while the transfer of lithium ions is facilitated, so that resistance may be suppressed, and thus the overall performance of the all-solid-state rechargeable battery may be improved. Herein, the average particle diameter (D50) of the solid electrolyte may be measured through a particle size analyzer using a laser diffraction method. Alternatively, about 20 particles may be arbitrarily selected from a micrograph of a scanning electron microscope or the like, the particle size is measured, and a particle size distribution is obtained, and the D50 value may be calculated.

The solid electrolyte layer may further include a binder in addition to the solid electrolyte. In an implementation, the binder may include, e.g., a styrene butadiene rubber, polytetrafluoroethylene, polyvinylidene fluoride, polyethylene, an acrylate polymer, or a combination thereof. The acrylate polymer may include, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may include, e.g., isobutyryl isobutyrate, xylene, toluene, benzene, hexane, or a combination thereof.

A thickness of the solid electrolyte layer may be, e.g., about 10 μm to about 150 μm.

The solid electrolyte layer may further include an alkali metal salt or an ionic liquid and/or a conductive polymer.

The alkali metal salt may be, e.g., a lithium salt. A content of the lithium salt in the solid electrolyte layer may be greater than or equal to about 1 M, e.g., about 1 M to about 4 M. In this case, the lithium salt may help improve ion conductivity by improving lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In an implementation, the lithium salt may include an imide salt, e.g., lithium bis(trifluoromethanesulfonyl) imide (LiTFSI, LiN(SO₂CF₃)₂), or lithium bis(fluorosulfonyl)imide (LiFSI, LiN(SO₂F)₂). The lithium salt may help maintain or improve ion conductivity by appropriately maintaining chemical reactivity with the ionic liquid.

The ionic liquid may have a melting point below room temperature, so it may be in a liquid state at room temperature and refers to a salt or room temperature molten salt composed of ions alone.

The ionic liquid may be a compound including a cation, e.g., an ammonium cation, pyrrolidinium cation, pyridinium cation, pyrimidinium cation, imidazolium cation, piperidinium cation, pyrazolium cation, oxazolium cation, pyridazinium cation, phosphonium cation, sulfonium cation, triazolium cation, or a mixture thereof, and at an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂, Cl, Br, I, BF₄⁻, SO₄⁻, CF₃SO₃⁻, (FSO₂)₂N⁻, (C₂F₅SO₂)₂N⁻, (C₂F₅SO₂)(CF₃SO₂)N, or (CF₃SO₂)₂N⁻.

The ionic liquid may include, e.g., N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ion conductivity by improving the electrochemical contact area with the electrode. Accordingly, the energy density, discharge capacity, rate capability, etc. of the all-solid-state battery may be improved.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

In an implementation, the shape of the all-solid-state battery may be, e.g., a coin type, a button type, a sheet type, a stack type, a cylindrical shape, a flat type, or the like. In an implementation, the all-solid-state battery may be applied to a large-sized battery used in an electric vehicle or the like. In an implementation, the all-solid-state battery may also be used in a hybrid vehicle such as a plug-in hybrid electric vehicle (PHEV). In an implementation, it may be used in a field requiring a large amount of power storage, and may be used, e.g., in an electric bicycle or a power tool.

Hereinafter, examples and comparative examples are described. It is to be understood, however, that the examples are for the purpose of illustration and are not to be construed as limiting.

### Example 1

1. Preparation of Solid Electrolyte

An argyrodite-type sulfide solid electrolyte was synthesized through a method described below. All processes of mixing raw materials and pre-heat treatment and post-heat treatment were performed in a glove box under an argon atmosphere. The raw materials of lithium sulfide (Li₂S), phosphorus pentasulfide (P₂S₅), and lithium chloride (LiCl) were mixed in a molar ratio of 2.5:0.5:1, to prepare a mixed powder. The mixed powder was uniformly mixed with a Henschel mixer and then, primarily fired at 250° C. for 5 hours in a tube furnace through which argon gas was flowing at a constant speed of 8 SLM.

The primarily fired powder was uniformly mixed again with the Henschel mixer, sieved, and then, secondarily fired at 500° C. for 10 hours in the tube furnace through which argon gas was flowing at the constant speed of 8 SLM. The secondarily fired powder was pulverized and sieved, to obtain sulfide solid electrolyte particles of Li₆PS₅Cl. This obtained sulfide solid electrolyte particles had a size (D50) of 0.85 km.

100 parts by weight of the prepared sulfide solid electrolyte particles and 0.25 parts by weight of lithium-zirconium-phosphate (LZP; LiZr₂(PO₄)₃) having D50 of 0.15 m and being amorphous as a result of X-ray diffraction analysis (as a coating agent) were mixed with the Henschel mixer. The mixed powder was subjected to heat treatment at 250° C. for 5 hours in the tube furnace through which argon gas was flowing at the constant speed of 8 SLM. Through this, a solid electrolyte having the lithium-zirconium-phosphate coated on the surface of the sulfide solid electrolyte particles was prepared.

2. Manufacture of Positive Electrode

13.61 wt % of the prepared solid electrolyte, 84.9 wt % of a positive electrode active material, LiNi_{0.944}Co_{0.04}Al_{0.012}Mn_{0.004}O₂, 1 wt % of a PVdF binder, 0.35 wt % of a conductive material, carbon nanotubes, and 0.14 wt % of a dispersant, a hydrogenated nitrile butadiene rubber (HNBR), were added to a solvent, isobutyryl isobutyrate (IBIB) and then, mixed, preparing a positive electrode composition.

The prepared positive electrode composition was coated on a positive electrode current collector and then, dried and compressed (warm isostatic press (WIP), 500 Mpa, 85° C., 30 μmin), manufacturing a positive electrode.

3. Manufacture of All-solid-state Rechargeable Battery Cell

After preparing a catalyst by mixing carbon black (primary particle diameter of about 30 nm) and silver (Ag) (average particle diameter (D50) of about 60 nm) in a weight ratio of 3:1, 0.25 g of the catalyst was added to 2 g of an NMP solution including 7 wt % of a polyvinylidene fluoride binder and then, mixed, preparing a negative electrode catalyst layer composition. This composition was coated on a negative electrode current collector and dried, preparing a precipitation-type negative electrode having a negative electrode catalyst layer on the current collector.

An argyrodite-type solid electrolyte of Li₆PS₅Cl was added to an IBIB solvent to which an acryl binder was included, preparing a composition for a solid electrolyte layer. The composition was cast on a releasing film and then, dried at ambient temperature, forming a solid electrolyte layer.

After cutting the prepared positive electrode, negative electrode, and solid electrolyte layer, the solid electrolyte layer was stacked on the positive electrode, and the negative electrode was stacked thereon. The stacked product was sealed into a pouch shape and then, pressed (warm isostatic press (WIP)) at a high temperature of 80° C. to 500 MPa for 30 minutes, manufacturing an all-solid-state rechargeable battery cell.

### Example 2

A solid electrolyte, a positive electrode, and an all-solid-state rechargeable battery cell were manufactured in the same manner as in Example 1 except that 0.5 parts by weight of the lithium-zirconium-phosphate coating agent was added to prepare the solid electrolyte.

### Example 3

A solid electrolyte, a positive electrode, and an all-solid-state rechargeable battery cell were manufactured in the same manner as in Example 1 except that 0.75 parts by weight of the lithium-zirconium-phosphate coating agent was added to prepare the solid electrolyte.

### Example 4

A solid electrolyte, a positive electrode, and an all-solid-state rechargeable battery cell were manufactured in the same manner as in Example 1 except that 1.0 part by weight of the lithium-zirconium-phosphate coating agent was added to prepare the solid electrolyte.

### Comparative Example 1

A solid electrolyte, a positive electrode, and an all-solid-state rechargeable battery cell were manufactured in the same manner as in Example 1 except that the solid electrolyte was prepared without using a lithium-zirconium-phosphate coating agent, and performing a heat treatment at 250° C. for 5 hours.

### Comparative Example 2

A solid electrolyte, a positive electrode, and an all-solid-state rechargeable battery cell were manufactured in the same manner as in Example 2 except that the solid electrolyte was prepared by mixing the lithium-zirconium-phosphate coating agent with sulfide solid electrolyte particles and changing the heat treatment temperature to 500° C., and LiNi_{0.944}Co_{0.04}Al_{0.012}Mn_{0.004}O₂ having a Li₂O—ZrO₂ buffer layer was used as a positive electrode active material.

In Comparative Example 2, the buffer layer of the positive electrode active material was formed in a wet coating method as follows. After mixing 2-propanol (from which moisture had been removed), a methanol solution containing 10% lithium methoxide, and zirconium isopropoxide in a molecular ratio (molar ratio) of 200:2:1, the positive electrode active material was dispersed therein. In order to prevent aggregation of the positive electrode active material particle, the solvent was evaporated at 50° C. under vacuum, while irradiating ultrasonic waves. A resulting material therefrom was filtered and heat-treated at 350° C. under an air atmosphere for 1 hour, obtaining the positive electrode active material coated with about 0.25 wt % of Li₂O—ZrO₂ as the buffer layer.

### Comparative Example 3

A solid electrolyte, a positive electrode, and an all-solid-state rechargeable battery cell were manufactured in the same manner as in Example 1 except that the solid electrolyte was prepared without performing the coating process.

### Comparative Example 4

A solid electrolyte, a positive electrode, and an all-solid-state rechargeable battery cell were manufactured in the same manner as in Comparative Example 3 except that LiNi_{0.944}Co_{0.04}Al_{0.012}Mn_{0.004}O₂ coated with a Li₂O—ZrO₂ buffer layer was prepared as the positive electrode active material. The buffer layer of the positive electrode active material was formed in the same method as in Comparative Example 2.

Table 1 shows design details of the solid electrolytes and the positive electrode active materials of Examples 1 to 4 and Comparative Examples 1 to 4.

TABLE 1

| | Additional | LZP | Buffer layer of |
|---|---|---|---|
| | heat | (parts by | positive electrode |
| | treatment | weight) | active material |
| Example 1 | 250° C. | 0.25 | — |
| Example 2 | | 0.5 | — |
| Example 3 | | 0.75 | — |
| Example 4 | | 1.0 | — |
| Comparative Example 1 | | — | — |
| Comparative Example 2 | 500° C. | 0.5 | Li₂O—ZrO₂ (wet) |
| Comparative Example 3 | None | — | — |
| Comparative Example 4 | Nobe | — | Li₂O—ZrO₂ (wet) |

### Evaluation Example 1: Evaluation of Particle Size Distribution of Solid Electrolyte

The particle size distributions of the solid electrolytes prepared in Examples 1 to 4 and Comparative Examples 1 to 3 were measured. The particle size distribution was measured by using xylene, from which moisture was removed, as a solvent and a particle size analyzer using a laser diffraction.

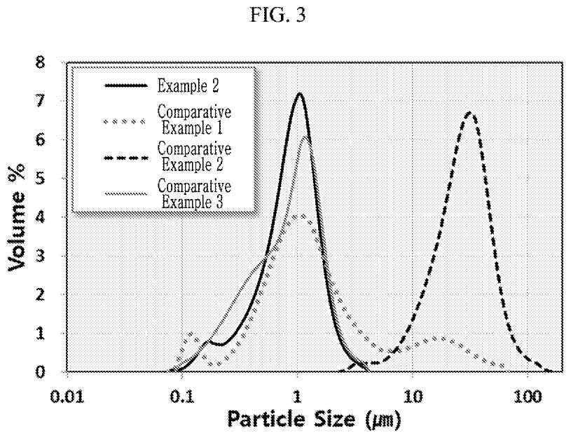

FIG. 3 shows particle size distribution curves of the solid electrolytes prepared in Example 2 and Comparative Examples 1 to 3. In FIG. 3, the horizontal axis is the particle size (μm) and the vertical axis is the cumulative volume (volume %) of the particles. In addition, in each particle size distribution of the solid electrolytes of Examples 1 to 4 and Comparative Examples 1 to 3, a cumulative volume 10% as D10, a cumulative volume 50% as D50, and a cumulative volume 90% as D90 are shown in Table 2. Furthermore, (D90-D10)/D50 was calculated to compare wideness of each particle size distribution and then, provided as Span in Table 2.

TABLE 2

| unit μm | D10 | D50 | D90 | Span |
|---|---|---|---|---|
| Example 1 | 0.230 | 0.681 | 1.448 | 1.8 |
| Example 2 | 0.329 | 0.868 | 1.550 | 1.4 |
| Example 3 | 0.261 | 0.870 | 1.457 | 1.4 |
| Example 4 | 0.349 | 0.875 | 1.636 | 1.5 |
| Comparative Example 1 | 0.369 | 1.144 | 12.890 | 10.9 |
| Comparative Example 2 | 11.520 | 26.820 | 49.950 | 1.43 |
| Comparative Example 3 | 0.260 | 0.848 | 1.644 | 1.6 |

Referring to FIG. 3, Comparative Example 1, in which a heat treatment was performed without a coating agent, exhibited aggregation of solid electrolyte particles themselves, compared to Comparative Example 3 before the heat treatment. In addition, referring to Table 2, as the solid electrolyte particles were aggregated, Comparative Example 1 exhibited very large D90 and span. If the heat treatment were to be additionally performed in order to increase ion conductivity of the pulverized sulfide solid electrolyte particles and the like, there could be a problem of aggregation among the particles.

Examples 1 to 4, which were appropriately coated with an amorphous coating agent, as shown in FIG. 3 and Table 2, exhibited a uniform particle size distribution without particle growth after the coating.

In addition, through this particle size distribution analysis, in the final solid electrolytes, coating agent particles with D50 of about 0.15 μm were not separately present from the sulfide solid electrolyte particles, but rather evenly coated on the surface of the sulfide solid electrolyte particles.

Comparative Example 2, in which the coating was performed with the same content as in Example 2, but a heat treatment was performed at 500° C. (the same temperature as that for manufacturing the sulfide solid electrolyte), exhibited rapid particle growth as shown in FIG. 3 and Table 2. Comparative Example 2 exhibited, as shown in Table 2, 30 times larger D50 than Example 2 and, as shown in FIG. 3, a particle diameter distribution shifted toward a larger size, which confirms overall particle growth. If this solid electrolyte were to be mixed with a positive electrode active material, the solid electrolyte particles could have too large diameter size and distribution to penetrate into spaces between the positive electrode active material particles, this solid electrolyte may not succeed in manufacturing a positive electrode for an all-solid-state rechargeable battery in which a solid electrolyte is well in contact with the surface of a positive electrode active material, and even solid electrolyte particles themselves could be well connected each other. Accordingly, performance of the all-solid-state battery cell could be expected to be deteriorated.

### Evaluation Example 2: X-ray Diffraction Analysis of Solid Electrolyte

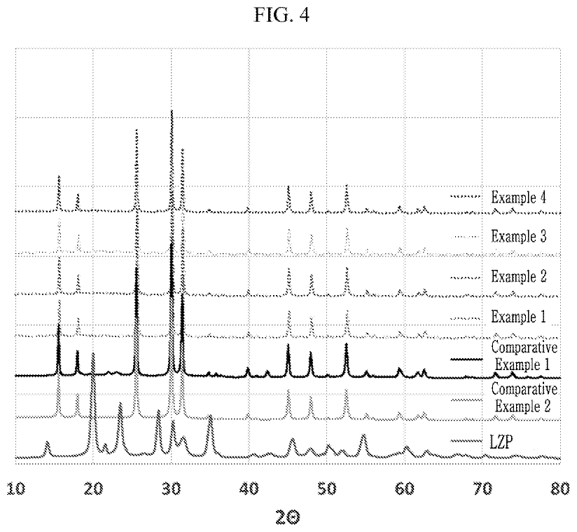

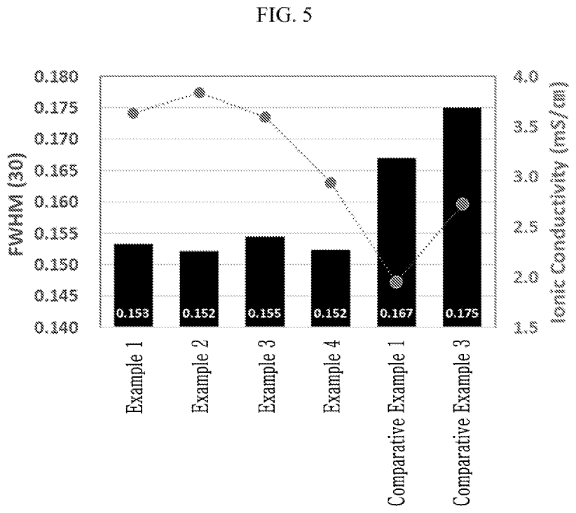

FIG. 4 shows X-ray diffraction (XRD) analysis results of the solid electrolytes of Examples 1 to 4, Comparative Examples 1 to 2, and the coating agent (LZP). In addition, a full width at half maximum (FWHM) of a peak with the highest diffraction intensity around 30° on a horizontal axis in FIG. 4 was calculated and then, shown as a bar graph in FIG. 5. Herein, the full width at half maximum (FWHM) of the main peak was a full width at half maximum (FWHM) corresponding to a miller index (222) which may be expressed as FWHM (222).

Referring to FIG. 4, Examples 1 to 4 exhibited no separate peak of the coating agent (LZP) itself and even Example 4 using a high content of the coating agent exhibited no LZO peak, indicating that the lithium-zirconium-phosphates on the surface of the sulfide solid electrolyte particles had very low crystallinity, e.g., were present in an amorphous state.

Referring to FIG. 5, Comparative Example 1, in which a heat treatment was performed at 250° C. without coating the coating agent, compared to Comparative Example 3, without an additional heat treatment, exhibited crystal growth due to a reduced full width at half maximum but a small increase of a crystal size, compared to Examples 1 to 4 in which the coating agent was well coated on the surface. As in Evaluation Example 1, the small increase of the crystal size of Comparative Example 1 may be understood due to a loss of thermal energy by aggregation of the solid electrolyte particles. If the surface of sulfide solid electrolyte were to be appropriately coated with amorphous lithium-metal-phosphate and then, heat-treated, the aggregation of the particles may be suppressed, but a crystal size of the particles may be increased.

### Evaluation Example 3: Evaluation of Ion Conductivity of Solid Electrolyte

0.15 g of each solid electrolyte of Examples 1 to 4 and Comparative Examples 1 and 3 was charged and pressed under a pressure of 40 kgf/cm², manufacturing each torque cell. The manufactured cells were calculated with respect to ion conductivity through electrochemical impedance spectroscopy (EIS), and the results are shown as a dotted line graph in FIG. 5. EIS was performed at an amplitude of about 10 mV and a frequency of 0.1 Hz to 10⁶ Hz under an air atmosphere at 25° C. The ion conductivity was calculated by obtaining resistance from a circular arc of a Nyquist plot through EIS and considering a thickness and an area, or the like, of each cell.

Referring to FIG. 5, Comparative Example 1, in which an additional heat treatment was performed, compared to Comparative Example 3, having no coating process, exhibited a low full width at half maximum (FWHM) and improved crystallinity, but exhibited particle aggregation and thus reduced ion conductivity. The sulfide solid electrolytes appropriately coated with a coating agent according to Examples 1 to 4 were suppressed from aggregation of particles themselves, but used thermal energy for crystal growth, and thus exhibited a greatly increased crystal size, resulting in significantly improved ion conductivity. Example 4, in which a content of the coating agent was increased, exhibited only a slightly reduced ion conductivity due to aggregation of the sulfide solid electrolyte particles or resistance on the surface thereof.

### Evaluation Example 4: Evaluation of Moisture Stability of Solid Electrolyte

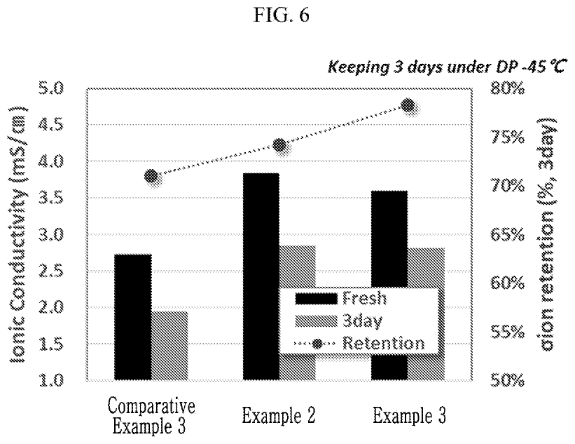

The solid electrolytes of Examples 2 and 3 and Comparative Example 3 were left in a dry room at a dew point of −45° C. for 3 days and then, measured with respect to ion conductivity in the same manner as in Evaluation Example 3. The results are shown in FIG. 6. In FIG. 6, the ion conductivity before being left is shown in a black bar graph, the ion conductivity after being left is shown in a gray bar graph, and the ion conductivity retention before and after being left is shown in a dotted line graph.

Referring to FIG. 6, in Examples 2 and 3, it may be seen that as crystallinity improved, high initial ion conductivity was obtained, and in addition, as the solid electrolytes were well protected by amorphous LZP, high ion conductivity retention and thus high stability against moisture was obtained.

### Evaluation Example 5: Evaluation of Initial Charge and Discharge Capacity of all-Solid-State Rechargeable Battery Cell

The all-solid-state rechargeable battery cells of Examples 1 to 4 and Comparative Examples 1 to 4 were full charged to an upper voltage limit of 4.25 V at a constant current of 0.1 C and at a constant voltage to 0.05 C at 45° C. and then, measured with respect to initial charge capacity and subsequently, discharged to a cut-off voltage of 2.5 V at 0.1 C and then, measured with respect to initial discharge capacity, and the results are shown in Table 3, and in addition, a ratio of the discharge capacity to the charge capacity is calculated and shown as efficiency in Table 3.

TABLE 3

| | Charge capacity | Discharge capacity | Efficiency |
|---|---|---|---|
| | (mAh/g) | (mAh/g) | (%) |
| Example 1 | 248.7 | 202.4 | 81.4% |
| Example 2 | 249.7 | 203.2 | 81.4% |
| Example 3 | 249.5 | 202.0 | 81.0% |
| Example 4 | 248.7 | 201.7 | 81.1% |
| Comparative Example 1 | 231.0 | 182.6 | 79.0% |
| Comparative Example 2 | 240.6 | 197.9 | 82.3% |
| Comparative Example 3 | 226.7 | 198.0 | 87.3% |
| Comparative Example 4 | 240.4 | 200.2 | 83.3% |

Referring to Table 3, compared to Comparative Example 3 (in which a positive electrode active material and a solid electrolyte had no buffer layer), in Comparative Example 4 (in which a buffer layer was coated on a positive electrode active material), charge capacity was significantly improved, and also discharge capacity was improved. Formation of a depletion layer during lithium transfer between positive electrode active material and solid electrolyte, which is a function of a buffer layer, was suppressed, resistance of the lithium transfer was reduced, significantly improving charge capacity and thereby, also improving discharge capacity.

In Examples 1 to 4, a coating layer on the solid electrolyte surface served as a buffer layer, unlike when coating the buffer layer on the positive electrode active material surface. Amorphous LZP on the solid electrolyte surface served as a buffer layer, improving charge capacity and discharge capacity. In Comparative Example 4, the positive electrode active material surface was wet-coated by using an alkoxide raw material and alcohol as a solvent. This may require an additional heat treatment by supplying air controlled with atmospheric conditions or humidity to remove alkoxide remaining on the surface and thus to suppress generation of residual carbon. This is a process of converting the alkoxide into alcohol to completely remove the alkoxide. A sulfide solid electrolyte may have high reactivity with moisture, and the residual carbon generation could be difficult to suppress by this method, resultantly deteriorating performance of an all-solid-state rechargeable battery cell.

In addition, after coating the solid electrolyte and increasing the heat treatment temperature from 250° C. to 500° C. as in Comparative Example 2, if a positive electrode coated with the same buffer layer as in Comparative Example 4 were to be applied, discharge capacity could decrease. As in Evaluation Example 1, the solid electrolyte of Comparative Example 2 had very large size and wider distribution than the positive electrode active material, and the solid electrolyte particles may hardly penetrate into spaces between the positive electrode active material particles. Accordingly, in Comparative Example 2, a solid electrolyte surrounded a positive electrode active material in a positive electrode plate well, and thus may not play a role of facilitating transfer of lithium ions. The solid electrolyte was well connected by itself and thus may not play a role of facilitating transfer of lithium ions between positive electrode and positive electrode, and initial charge and discharge capacity of an all-solid-state rechargeable battery cell decreases.

### Evaluation Example 6: Cycle-Life Characteristics of all-Solid-State Rechargeable Battery Cells

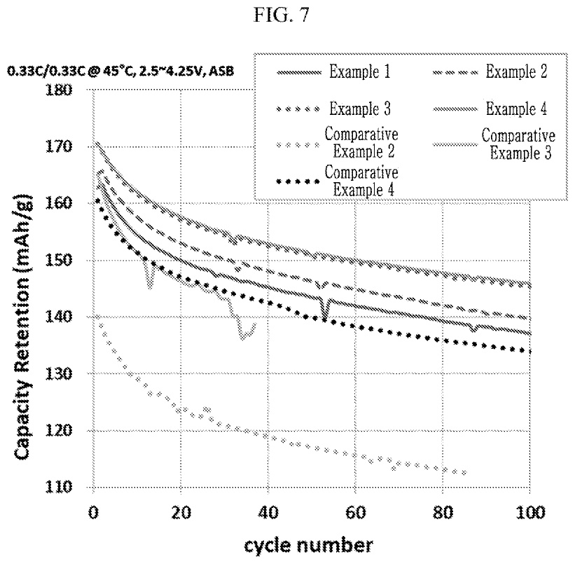

After performing the same initial charge and discharge of the all-solid-state rechargeable battery cells of Examples 1 to 4 and Comparative Examples 2 to 4 as in Evaluation Example 5, the cells were repeatedly charged and discharged at 0.33 C within a voltage range of 2.5 V to 4.25 V at 45° C. and then, evaluated with respect to cycle-life characteristics, and the results are shown in FIG. 7.

Referring to FIG. 7, compared to Comparative Example 4, Examples 1 to 4 exhibited much more excellent cycle-life characteristics. In the all-solid-state rechargeable battery cell of Comparative Example 2, it may be seen that cycle-life characteristics were significantly deteriorated as a heat treatment temperature was changed during the solid electrolyte coating. The reason explained in Evaluation Example 5 may be understood to have more influences on cycle-life characteristics, which are evaluated by a higher current. It could be difficult for lithium ions to transfer between positive electrode and positive electrode, and cell resistance could be high, wherein an increase in a current for the evaluation from 0.1 C to 0.33 C may be understood to bring about a larger decrease in capacity.

By way of summation and review, a solid electrolyte, compared to the liquid electrolyte, may have low ion conductivity, resistance on the interface with solid particles of a positive electrode active material and the like in a battery, deterioration of the ion conduction performance by formation of a depletion layer by solid-to-solid bonding, and the like.

In order to address these issues, doping various elements into the positive electrode active material particles used with the solid electrolyte and forming a buffer layer including various elements such as B, Nb, Zr, and the like on the surface of the positive electrode active material particles have been used. However, these methods could have difficulties in mass production, could cause coat and environmental problems, and could still have limitations in improving performance of the all-solid-state battery.

One or more embodiments may provide a solid electrolyte with high ion conductivity and high crystallinity and improved moisture stability, which may be applied to a positive electrode to help improve capacity and charge/discharge efficiency of the all-solid-state rechargeable battery and to improve cycle-life characteristics.

The positive electrode for an all-solid-state rechargeable battery according to some example embodiments may include a solid electrolyte having high ion conductivity and high crystallinity and excellent moisture stability, so that it is possible to use the positive electrode active material without forming a buffer layer, which is used in liquid electrolyte systems, as it is, and to improve the charge-discharge efficiency, capacity, and cycle-life characteristics of all-solid-state rechargeable batteries

Example embodiments have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A positive electrode for an all-solid-state rechargeable battery, the positive electrode comprising:
a current collector; and
a positive electrode active material layer on the current collector,
wherein:
the positive electrode active material layer includes a positive electrode active material and a solid electrolyte,
the solid electrolyte includes:
sulfide solid electrolyte particles, and
a lithium-metal-phosphate on a surface of the sulfide solid electrolyte particles, and
in an X-ray diffraction analysis of the solid electrolyte, a full width at half maximum of a main peak is less than or equal to about 0.160.

2. The positive electrode as claimed in claim 1, wherein, in the lithium-metal-phosphate, the metal is Al, B, Ca, Ce, Cr, Fe, Mg, Mo, Nb, Si, Sn, Sr, Ta, V, W, or Zr.

3. The positive electrode as claimed in claim 1, wherein the lithium-metal-phosphate is included in the solid electrolyte in an amount of about 0.01 wt % to about 3 wt %, based on a total weight of the solid electrolyte.

4. The positive electrode as claimed in claim 1, wherein the lithium-metal-phosphate is included in the solid electrolyte in an amount of about 0.01 wt % to about 0.8 wt %, based on a total weight of the solid electrolyte.

5. The positive electrode as claimed in claim 1, wherein the lithium-metal-phosphate is amorphous.

6. The positive electrode as claimed in claim 1, wherein the sulfide solid electrolyte particles include an argyrodite-type sulfide.

7. The positive electrode as claimed in claim 1, wherein an average particle diameter (D50) of the solid electrolyte is about 0.1 μm to about 5.0 μm.

8. The positive electrode as claimed in claim 1, wherein an average particle diameter (D50) of the sulfide solid electrolyte is about 0.1 μm to about 2.0 μm.

9. The positive electrode as claimed in claim 1, wherein a value of (D90-D10)/D50 in a particle size distribution for the solid electrolyte is greater than about 1 and less than or equal to about 5.

10. The positive electrode as claimed in claim 1, wherein the solid electrolyte is included in the positive electrode active material layer in an amount of about 0.5 wt % to about 35 wt %, based on a total weight of the positive electrode active material layer.

11. The positive electrode as claimed in claim 1, wherein:
the positive electrode active material is in the form of particles, and
the particles do not include a buffer layer.

12. The positive electrode as claimed in claim 1, wherein the positive electrode active material includes a lithium cobalt oxide, lithium nickel oxide, a lithium nickel cobalt oxide, a lithium nickel cobalt aluminum oxide, a lithium nickel cobalt manganese oxide, a lithium nickel manganese oxide, a lithium manganese oxide, a lithium iron phosphate, or a combination thereof.

13. The positive electrode as claimed in claim 1, wherein:
the positive electrode active material includes a lithium nickel oxide represented by Chemical Formula 1, a lithium cobalt oxide represented by Chemical Formula 2, a lithium iron phosphate compound represented by Chemical Formula 3, or a combination thereof,
Liₐ₁Niₓ₁M¹_{y1}M²_{1-x1-y1}O₂ [Chemical Formula 1]
in Chemical Formula 1, 0.9≤a1≤1.8, 0.3≤x1≤1, 0≤y1≤0.7, and M¹ and M² are each independently Al, B, Ba, Ca, Ce, Co, Cr, Cu, F, Fe, Mg, Mn, Mo, Nb, P, S, Si, Sr, Ti, V, W, or Zr,
Liₐ₂Coₓ₂M³₁₋ₓ₂O₂ [Chemical Formula 2]
in Chemical Formula 2, 0.9≤a2≤1.8, 0.6≤x2≤1, and M³ is Al, B, Ba, Ca, Ce, Cr, Cu, F, Fe, Mg, Mn, Mo, Nb, P, S, Si, Sr, Ti, V, W, or Zr, and
Liₐ₃Feₓ₃M⁴₍₁₋ₓ₃₎PO₄ [Chemical Formula 3]
in Chemical Formula 3, 0.9≤a3≤1.8, 0.6≤x3≤1, and M⁴ is Al, B, Ba, Ca, Ce, Co, Cr, Cu, F, Fe, Mg, Mn, Mo, Nb, P, S, Si, Sr, Ti, V, W, or Zr.

14. The positive electrode as claimed in claim 1, wherein an average particle diameter (D50) of the positive electrode active material is about 3 μm to about 25 μm.

15. The positive electrode as claimed in claim 1, wherein the positive electrode active material layer includes:
about 50 wt % to about 99.5 wt % of the positive electrode active material,
about 0.5 wt % to about 35 wt % of the solid electrolyte,
about 0 wt % to about 10 wt % of a binder, and
about 0 wt % to about 5 wt % of a conductive material, based on a total weight of the positive electrode active material layer.

16. An all-solid-state rechargeable battery, comprising:
the positive electrode as claimed in claim 1;
a negative electrode; and
a solid electrolyte layer between the positive electrode and the negative electrode.

17. The all-solid-state rechargeable battery as claimed in claim 16, wherein the negative electrode includes a current collector and a negative electrode active material layer or a negative electrode catalyst layer on the current collector.

18. The all-solid-state rechargeable battery as claimed in claim 16, wherein the negative electrode includes:
a current collector,
a negative electrode catalyst layer on the current collector, and
a lithium metal layer formed during initial charging between the current collector and the negative electrode catalyst layer.

19. The all-solid-state rechargeable battery as claimed in claim 16, wherein:
the solid electrolyte layer includes a solid electrolyte, and
an average particle diameter (D50) of the solid electrolyte included in the positive electrode is smaller than an average particle diameter (D50) of the solid electrolyte included in the solid electrolyte layer.

20. The all-solid-state rechargeable battery as claimed in claim 19, wherein:
the average particle diameter (D50) of the solid electrolyte included in the positive electrode is about 0.5 μm to about 2.0 μm, and
the average particle diameter (D50) of the solid electrolyte included in the solid electrolyte layer is about 2.1 μm to about 5.0 μm.
